(19) United States
(12) Patent Application Publication
(10) Pub. No.: US 2010/0177941 A1
(43) Pub. Date: Jul. 15, 2010

(54) MEDICAL IMAGE DIAGNOSIS SUPPORT SYSTEM AND IMAGE PROCESSING METHOD

(75) Inventors: Hideto Shiozawa, Suwa-shi (JP); Tsukasa Sako, Yokohama-shi (JP); Koji Takekoshi, Yokohama-shi (JP); Yuichi Nishii, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/646,801

(22) Filed: Dec. 23, 2009

(30) Foreign Application Priority Data
Jan. 9, 2009 (JP) 2009-003990

(51) Int. Cl. G06K 9/00

(52) U.S. Cl. 382/128

(57) ABSTRACT

A medical image diagnosis support system is configured to improve the processing efficiency and analysis accuracy of CAD processing. This invention is a medical image diagnosis support system which includes a CAD server and a PACS/viewer apparatus. This system includes a first processing path in which a processed image obtained by executing image processing including noise suppression processing or sharpening processing for a medical image obtained by the imaging apparatus is stored in the PACS/viewer apparatus, a second processing path in which a CAD result obtained by executing CAD processing for a medical image obtained by the imaging apparatus is stored in the PACS/viewer apparatus, and a processing unit configured to execute a process of associating the processed image with the CAD result in the first processing path and the second processing path.

### BACKGROUND OF THE INVENTION

1. Field of the Invention

The present invention relates to a medical image diagnosis support system.

2. Description of the Related Art

Currently, the formulation and proliferation of guidelines such as DICOM standards and IHE allow not only imaging apparatuses but also other types of apparatuses to process, manage, and browse medical images.

For example, an image storage apparatus such as a PACS can manage the medical images obtained by an imaging apparatus after the images are sent to the image storage apparatus such as a PACS. An image storage apparatus such as a PACS can be connected to a plurality of imaging apparatuses, and can collectively manage various types of medical images.

In addition, with the recent development of CAD (Computer Aided Detection/Diagnosis) techniques, it has become possible to perform CAD processing for supporting doctors' diagnosis on obtained medical images. Note that CAD processing in this case indicates processing for the analysis of medical images, for example, lesion detection, the measurement of a cardiothoracic ratio or the like, the determination of a symptom such as dementia, and lesion detection after the generation of three-dimensional information.

Furthermore, as one type of CAD processing, there has been proposed a technique of generating a plurality of images by applying an adaptive ring filter to an original chest X-ray image, and detecting a lesion (see Japanese Patent Laid-Open No. 2002-112985).

In order to perform various types of CAD processing for obtained medical images in this manner, an imaging apparatus generally may have a CAD processing function. As described above, however, a plurality of imaging apparatuses are often installed. It is therefore undesirable from the viewpoint of processing efficiency to make all the imaging apparatuses have CAD processing functions.

On the other hand, in consideration of processing efficiency, a CAD apparatus dedicated to CAD processing may be installed independently of imaging apparatuses and an image storage apparatus such as a PACS.

In many cases, however, an imaging apparatus outputs obtained medical images upon performing image processing for them so as to output medical images allowing a doctor to easily diagnose. Although such image processing can generate medical images allowing a doctor to easily diagnose, the processing changes signals. This processing therefore inevitably degrades original image signals.

That is, if a CAD apparatus is installed independently of imaging apparatuses and an image storage apparatus such as a PACS, the medical images obtained by imaging apparatuses and output to the CAD apparatus have undergone signal degradation. That is, such images are not suitable for signal analysis. This may lead to the degradation of the analysis accuracy of CAD processing.

### SUMMARY OF THE INVENTION

The present invention has been made in consideration of the above problem.

A medical image diagnosis support system according to the present invention has the following arrangement. That is, a medical image diagnosis support system comprising an imaging apparatus which images an object, a processing apparatus which executes CAD processing of analyzing an input medical image, and a storage apparatus which stores input information, the imaging apparatus, the processing apparatus, and the storage apparatus being connected to each other, the system comprising: a first processing path in which information obtained by executing image processing including one of noise suppression processing and sharpening processing for a medical image obtained by making the imaging apparatus image the object is stored in the storage apparatus; a second processing path in which information obtained by executing the CAD processing for a medical image obtained by making the imaging apparatus image the object is stored in the storage apparatus; and a processing unit configured to execute, in the first processing path and the second processing path, a process of associating the information stored in the storage apparatus in the first processing path with the information stored in the storage apparatus in the second processing path.

According to the present invention, the medical image diagnosis support system can improve the processing efficiency and analysis accuracy of CAD processing.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the arrangement of a medical image diagnosis support system according to the first embodiment of the present invention;

FIG. 2 is a block diagram showing the basic hardware arrangement of an imaging apparatus 101, CAD server 102, and PACS/viewer apparatus 103;

FIG. 3 is a block diagram showing the functional arrangement of the imaging apparatus 101, CAD server 102, and PACS/viewer apparatus 103;

FIG. 4 is a flowchart showing a processing procedure in the medical image diagnosis support system (a processing procedure to be performed when a medical image acquired by one imaging operation is processed);

FIG. 5 is a block diagram showing the functional arrangement of each apparatus constituting a medical image diagnosis support system according to the second embodiment of the present invention;

FIG. 6 is a flowchart showing a processing procedure in the medical image diagnosis support system (a processing procedure to be performed when a medical image acquired by one imaging operation is processed);

FIG. 7 is a view showing the arrangement of a medical image diagnosis support system according to the third embodiment of the present invention;

FIG. 8 is a block diagram showing the functional arrangement of each apparatus constituting the medical image diagnosis support system;

FIG. 9 is a flowchart showing a processing procedure in the medical image diagnosis support system (a processing procedure to be performed when a medical image acquired by one imaging operation is processed);

FIG. 10 is a view showing the arrangement of a medical image diagnosis support system according to the fourth embodiment of the present invention;

FIG. 11 is a block diagram showing the functional arrangement of each apparatus constituting the medical image diagnosis support system;

FIG. 12 is a flowchart showing a processing procedure in the medical image diagnosis support system (a processing procedure to be performed when a medical image acquired by one imaging operation is processed);

FIG. 13 is a view showing the arrangement of a medical image diagnosis support system according to the fifth embodiment of the present invention;

FIG. 14 is a block diagram showing the functional arrangement of each apparatus constituting the medical image diagnosis support system; and

FIG. 15 is a flowchart showing a processing procedure in the medical image diagnosis support system (a processing procedure to be performed when a medical image acquired by one imaging operation is processed).

### DESCRIPTION OF THE EMBODIMENTS

Embodiments of the present invention will now be described in detail in accordance with the accompanying drawings.

### First Embodiment

### <1. Arrangement of Medical Image Diagnosis Support System>

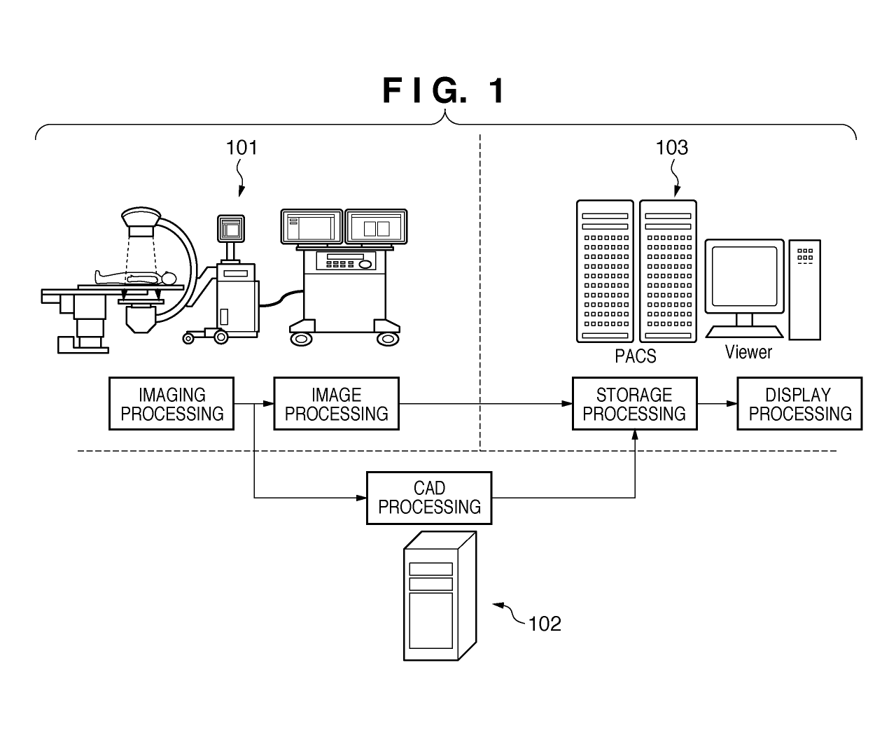

FIG. 1 is a view showing the arrangement of a medical image diagnosis support system according to the first embodiment of the present invention.

Reference numeral 101 denotes an imaging apparatus, for example, an X-ray imaging apparatus, X-ray CT, fundus camera, catheter camera, gastrocamera, ultrasonic apparatus, PET/SPECT, or MRI, which obtains medical images by imaging an object. Note that FIG. 1 shows an X-ray imaging apparatus as an imaging apparatus.

Reference numeral 102 denotes a CAD server which performs CAD processing; and 103, a PACS/viewer apparatus including PACS and viewer functions.

In the medical image diagnosis support system, the imaging apparatus 101, the CAD server 102, and the PACS/viewer apparatus 103 are configured to be connected to each other. This allows the imaging apparatus 101, the CAD server 102, and the PACS/viewer apparatus 103 to transmit and receive information among them. The arrows in FIG. 1 indicate the flows of information transmitted and received, such as images and data attached to images.

As indicated by the arrows in FIG. 1, in the medical image diagnosis support system according to this embodiment, the medical images obtained by imaging an object using the imaging apparatus 101 are transmitted to the CAD server 102 before they are image-processed in the imaging apparatus 101 (second processing path).

This allows the CAD server 102 to receive medical images (original images) free from signal degradation due to image processing and execute CAD processing for the medical images suitable for signal analysis.

On the other hand, the imaging apparatus 101 transmits the medical images obtained by imaging the object to the PACS/viewer apparatus 103 upon performing image processing for them (first processing path). That is, the images stored in the PACS/viewer apparatus 103 are images (processed images) allowing a doctor to easily diagnose.

In addition, the CAD server 102 transmits the good CAD results obtained by performing CAD processing for original images to the PACS/viewer apparatus 103.

The PACS/viewer apparatus 103 then stores the processed images and the CAD results upon associating them. This allows the PACS/viewer apparatus 103 to simultaneously display the processed image allowing a doctor to easily diagnose and the good CAD result.

According to this medical image diagnosis support system, even if a plurality of imaging apparatuses 101 are installed in a hospital, one CAD server 102 or a very small number of CAD servers 102 relative to the imaging apparatuses 101 will suffice. This can greatly reduce the cost as compared with a case in which each imaging apparatus has a CAD processing function.

In addition, the system can be configured to concurrently perform processing in the first processing path and processing in the second processing path. This concurrent processing can display a processed image and a CAD result more quickly. It is possible to display first one of the processed image and the CAD result from which a processing result is obtained first.

### <2. Hardware Arrangement of Each Apparatus Constituting Medical Image Diagnosis Support System>

The hardware arrangement of each apparatus (the imaging apparatus, CAD server, and PACS/viewer apparatus) constituting the medical image diagnosis support system will be described next.

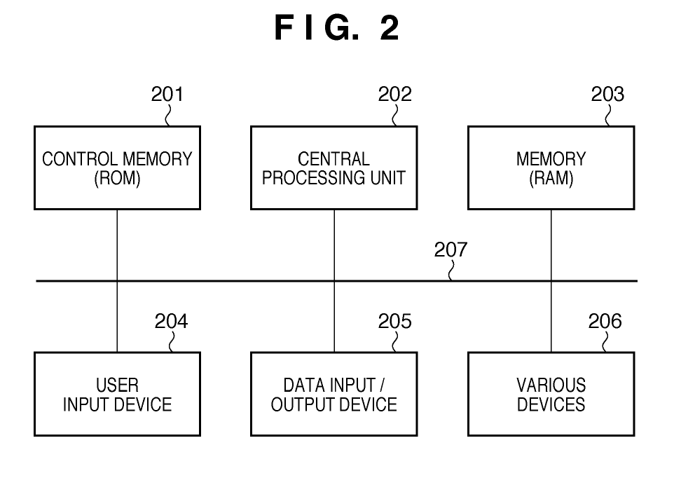

FIG. 2 is a block diagram showing the basic hardware arrangement of the imaging apparatus 101, CAD server 102, and PACS/viewer apparatus 103.

Referring to FIG. 2, reference numeral 201 denotes a control memory which stores control programs for implementing the functions which the respective apparatuses have and data used for the control programs; and 202, a central processing unit which executes these control programs and data.

Reference numeral 203 denotes a memory which temporarily stores a control program and data when the central processing unit 202 executes them.

Reference numeral 204 denotes a user input device which accepts inputs from the user; 205, a data input/output device which is in charge of data exchange with the outside; and 206, various devices representing the respective devices which the imaging apparatus 101, the CAD server 102, and the PACS/viewer apparatus 103 separately hold.

Reference numeral 207 denotes a bus which connects the control memory 201, central processing unit 202, memory 203, user input device 204, data input/output device 205, and various devices 206.

### <3. Functional Arrangement of Each Apparatus Constituting Medical Image Diagnosis Support System>

The functional arrangement of each apparatus (the imaging apparatus, CAD server, and PACS/viewer apparatus) constituting the medical image diagnosis support system will be described next.

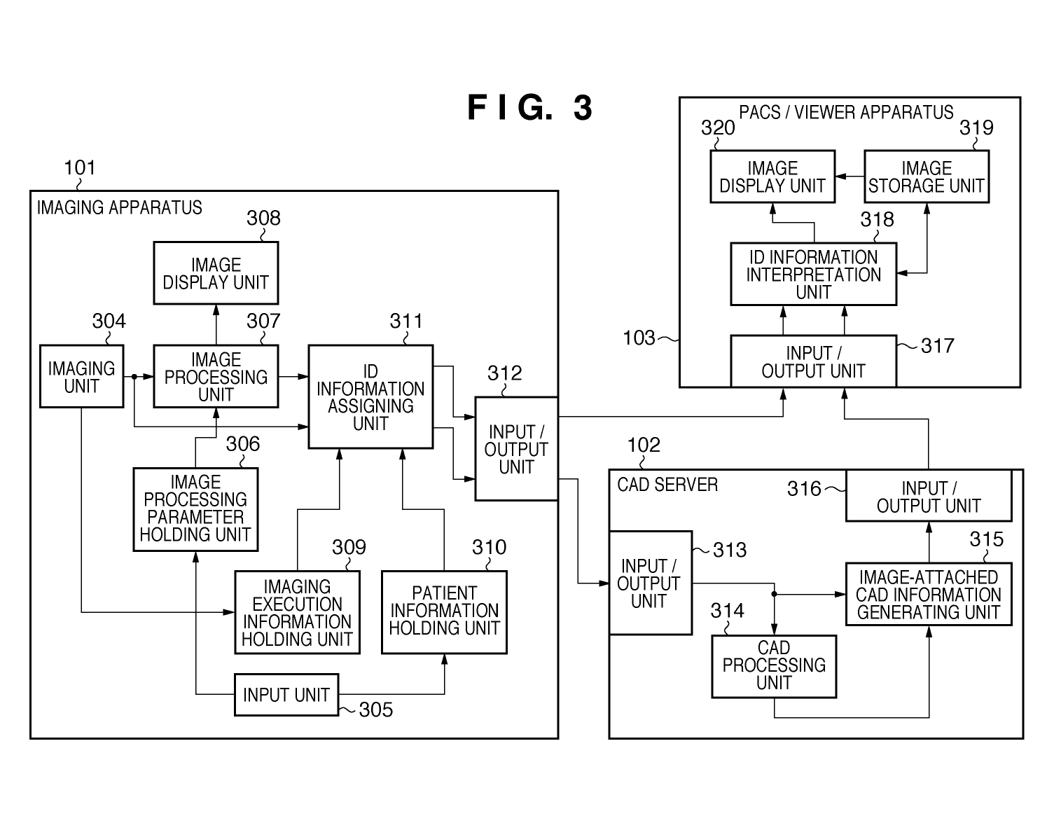

FIG. 3 is a block diagram showing the functional arrangement of the imaging apparatus 101, CAD server 102, and PACS/viewer apparatus 103.

Note that the arrow lines in FIG. 3 do not indicate any physical connection forms but represent the flows of communication sessions and information. Assume therefore that the functional arrangement in FIG. 3 includes a case in which, for example, the imaging apparatus 101 and the PACS/viewer apparatus 103 perform communication via a network.

The drawing is simplified by not illustrating any processing units for performing image display processing which is not directly associated with medical image diagnosis support processing, for example, an image display unit, display image processing unit, display image processing parameter holding unit, and display image processing parameter input unit. Assume, however, that any apparatuses described in not only this embodiment but also all the embodiments in this specification can include processing units which perform image display processing.

<3.1 Functional Arrangement of Imaging Apparatus>

The functional arrangement of the imaging apparatus 101 will be described first. Reference numeral 304 denotes an imaging unit. The imaging unit 304 can take various forms depending on the type of imaging apparatus 101. For example, the imaging unit 304 can take the following forms depending on the imaging apparatus 101.

If the imaging apparatus 101 is an X-ray imaging apparatus, the imaging unit 304 is implemented by hardware including an X-ray sensor and an X-ray generator, and software.

If the imaging apparatus 101 is an X-ray CT, the imaging unit 304 is implemented by hardware including an X-ray sensor, an X-ray generator, and a system which forms a CT slice image from information acquired by the sensor, and software.

If the imaging apparatus 101 is a fundus camera, catheter camera, or gastrocamera, the imaging unit 304 is implemented by hardware including a light-emitting source and an imaging apparatus such as a general/medical camera, and software.

If the imaging apparatus 101 is an ultrasonic apparatus, the imaging unit 304 is implemented by hardware including an ultrasonic element (e.g., a piezoelectric element) which generates/measures ultrasonic waves and a system which forms an image from an ultrasonic signal, and software.

If the imaging apparatus 101 is a PET/SPECT, the imaging unit 304 is implemented by hardware including a radioactive drug injection unit which injects a radioactive drug synthesized from a radioactive element (e.g., a positron emitter nuclide) and a system which forms an image from measured radiation, and software.

If the imaging apparatus 101 is an MRI or MRA apparatus, the imaging unit 304 is implemented by hardware including a coil which generates a magnetic field and a system which forms an image from a measured NMR signal, and software.

If the imaging apparatus 101 is a contrast-enhanced MRI apparatus, the imaging unit 304 is implemented by software and hardware including a contrast medium injection unit which injects an MRI contrast medium (e.g., a gadolinium compound or superparamagnetic iron oxide), in addition to the components of the imaging unit 304 of the MRI apparatus described above.

In addition to the above units, the imaging unit in this specification includes the imaging unit 304 obtained by combining the above imaging apparatuses, for example, a PET-CT. Assume that in this specification, the word “image” includes a still image, a set of still images, a moving image, a slice image, a set of slice images, and a volume image generated from a set of slice images.

Reference numeral 305 denotes an input unit including hardware input interfaces such as a keyboard, mouse, and barcode reader which accept inputs from the user.

Reference numeral 306 denotes an image processing parameter holding unit. The image processing parameter holding unit 306 holds an image processing parameter including at least a noise suppression parameter, a sharpness intensity, a rotational angle, an enlargement/reduction ratio, the execution/non-execution of horizontal/vertical reversal, the execution/non-execution of tone reversal, or an area to be sliced, which is input by the input unit 305.

Reference numeral 307 denotes an image processing unit implemented by software or hardware for performing image processing such as noise suppression processing, sharpening processing, rotation processing, enlargement/reduction processing, horizontal/vertical reversal processing, and tone reversal processing for the medial images obtained by the imaging unit 304. In the following description, an output image from the image processing unit 307 will be referred to as an “processed image”, and an image input to the image processing unit 307 and an equivalent image will be referred to as “original images”.

In general, the imaging unit 304 performs image processing for correcting characteristics dependent on an imaging apparatus, for example, a sensor characteristic, and the processing of uniforming information, for example, information normalization. However, the apparatus can be configured to make the image processing unit 307 perform such processing. In this case, an original image is a signal input from the sensor without any change or information obtained by correcting part of the characteristics of the signal.

Furthermore, this information can be information which does not take any image forms. The term “original image” in this specification is an expedient term, and is not limited by any image forms. If this apparatus is configured to make the image processing unit 307 perform correction of the characteristics of the imaging unit 304 and the like, the image processing parameter holding unit 306 holds parameters necessary for image processing such as correction. The image processing unit 307 can also perform the processing of reconstructing three-dimensional information from a plurality of obtained image data.

Reference numeral 308 denotes an image display unit which displays the image processed by the image processing unit 307. The image display unit 308 can also display an image which has not undergone any image processing.

Reference numeral 309 denotes an imaging execution information holding unit implemented by hardware which holds information required for imaging, for example, an imaging time, output from the imaging unit 304. Information to be held in this unit is information necessary for the generation of information in a DICOM form, and takes various forms depending on the form of the imaging apparatus. If, for example, the imaging apparatus 101 is an X-ray imaging apparatus, this information includes a tube current, a tube voltage, and the like.

Reference numeral 310 denotes a patient information holding unit implemented by hardware which holds information about a patient as an examination target, which is input or selected by the input unit 305 (from a work list acquired in advance by Order Filler such as HIS/RIS). The patient information holding unit 310 holds at least information necessary for the generation of information in a DICOM form.

Reference numeral 311 denotes an ID information assigning unit implemented by software for assigning at least ID information (identification information) to the image processed by the image processing unit 307.

The ID information assigning unit 311 assigns the same ID information as that of the processed image processed by the image processing unit 307 or ID reference information indicating the processed image to an original image from the imaging unit 304, which is the information on which the processed image is based.

Note that when assigning ID reference information, the ID information assigning unit 311 may assign an ID to the original image from the imaging unit 304 and assign reference information corresponding to the ID to the processed image from the image processing unit 307.

In the following description, this ID reference information will also be referred to as ID information. Assume that the ID information assigning unit 311 generates information in a DICOM form which is integrated with the information generated by the imaging execution information holding unit 309 and the patient information holding unit 310.

Although the expression “an image assigned with ID information” is used, this also includes a DICOM image.

Note that the ID information assigning unit 311 needs to recognize that two types of images, namely an original image and a processed image, are identical original images before image processing.

For this reason, although not shown in FIG. 3, an overall imaging apparatus 301 has established synchronization by using a signal from the imaging unit 304 or another clock held inside/outside the apparatus. Assume also that this apparatus is configured to discriminate, in terms of both software and hardware based on the synchronization signal, that the two types of images correspond to each other.

In addition, in this embodiment, ID information can take various forms. For example, this information can take the following forms:

a DICOM Image Instance UID

an ID conforming to the mechanism of a DICOM UID (obtained by adding an internal ID issued inside the apparatus to the MAC address of a network card)

a unique ID which is valid only within the hospital

a form which uses, for one type of image, a technique such as MD-5 for relatively uniquely specifying information, and makes the other type of image have the code as ID reference information

a form which uses the file name of one type of image as an ID and makes the other type of image have ID reference information, if the output form of an input/output unit 312 (to be described later) is a file-based output form.

The input/output unit 312 outputs two types of images (a processed image and an original image) assigned with IDs by the ID information assigning unit 311. Assume that the input/output unit 312 is implemented by a communication device such as an Ethernet card and software for controlling it. This unit may take a form that outputs such images to a portable medium such as a CD, DVD, or flash memory.

Assume that all the input/output units described below have the same form. That is, if the input/output unit 312 has a communication arrangement, other input/output units to be connected to the input/output unit 312 also have communication arrangements.

Although in this specification, each input/output unit is described as one block for the sake of simplicity, it is possible to divide each input/output unit into a plurality of blocks. For example, two output lines are connected to the input/output unit 312 in FIG. 3, it is possible to assign blocks called input/output units 312A and 312B to the output lines, respectively.

<3.2 Functional Arrangement of CAD Sever>

The functional arrangement of a CAD server 302 will be described next. Reference numeral 313 denotes an input/output unit implemented by hardware which accepts the original image output from the input/output unit 312 as an input, and software.

Reference numeral 314 denotes a CAD processing unit implemented by software for performing CAD processing for the original image input to the input/output unit 313. Note that the CAD processing unit 314 may be implemented by hardware if high-speed processing is required.

Assume also that CAD processing indicates the processing of performing image analysis, for example, lesion detection, the measurement of a cardiothoracic ratio, the determination of a symptom such as dementia, and lesion detection after the generation of three-dimensional information. In this case, if CAD processing includes lesion detection after the generation of three-dimensional information, image processing to be performed by the image processing unit 307 of the imaging apparatus 101 includes the processing of generating three-dimensional information.

Reference numeral 315 denotes an image-attached CAD information generating unit implemented by software which receives a CAD result from the CAD processing unit 314 and the ID information of an original image as inputs from the CAD processing unit 314, and generates a CAD result having the same ID information.

Assume that a CAD result indicates, for example, an analysis result such as the position information of a detected lesion, the type of lesion, an importance, the position at which a cardiothoracic ratio has been measured, or a measurement result.

Assume also that image-attached CAD information is information obtained by expressing the processing result obtained by the CAD processing unit 314 in a bitmap form, a bitmap/position information form, a vector information form, or a shape information/position information form.

Assume that image-attached CAD information can indicate a CAD result displayed by superimposing it on an original image of a CAD processing target. More specifically, the image-attached CAD information generating unit 315 generates a DICOM GSPS object. Assume that in the following description, image-attached CAD information includes this DICOM GSPS object.

Note that GSPS objects include two types of image-attached information forms, namely an overlay type and a graphic annotation type. For this reason, the image-attached CAD information generating unit 315 is configured to generate information in both or one of the forms.

Reference numeral 316 denotes an input/output unit implemented by hardware which outputs the image-attached CAD information generated by the image-attached CAD information generating unit 315, and software. Note that the input/output unit 313 and the input/output unit 316 can be implemented by one piece of hardware.

<3.3 Functional Arrangement of PACS/Viewer Apparatus>

The functional arrangement of a PACS/viewer apparatus 303 will be described next. Reference numeral 317 denotes an input/output unit implemented by hardware which accepts the processed image output from the input/output unit 312 of the imaging apparatus 301 and the image-attached CAD information output from the input/output unit 316 of the CAD server 302, and software.

Reference numeral 318 denotes an ID information interpretation unit implemented by software. The ID information interpretation unit 318 collates the ID information which an input processed image holds with the ID information contained in input image-attached CAD information. If these pieces of ID information match (or are associated with each other when they are pieces of ID reference information), the ID information interpretation unit 318 associates the two pieces of information with each other.

The ID information interpretation unit 318 can output input information to an image display unit 320 (to be described later). Reference numeral 319 denotes an image storage unit implemented by hardware which stores and manages a processed image and image-attached CAD information as related information based on the information associated by the ID information interpretation unit 318, and software.

If a processed image and image-attached CAD information reach the input/output unit 317 with a time lag, the ID information interpretation unit 318 outputs one of the pieces of information which has reached the ID information interpretation unit 318 first. The image storage unit 319 stores the information which has reached first.

When the other piece of information reaches next, the ID information interpretation unit 318 exchanges ID information with the image storage unit 319, and outputs the ID information and the information which has reached later to the image storage unit 319. Note that it is possible to exchange these pieces of ID information in several forms. For example, such forms include:

a method of making the ID information interpretation unit 318 acquire an ID information list of information stored in the image storage unit 319, that is, a form of making the ID information interpretation unit 318 collate the ID information of information, in the ID information list, which has reached later, and

a method of making the ID information interpretation unit 318 provide the image storage unit 319 with the ID information of information which has reached later and acquire corresponding ID information from the image storage unit 319 as a response, that is, a form of making the image storage unit 319 collate the ID information of information held in itself with the ID information sent from the ID information interpretation unit 318.

The image storage unit 319 stores one piece of information which has already reached and the other piece of information which has reached later upon associating them with each other based on related information. The image display unit 320 is implemented by hardware which displays the information output from the ID information interpretation unit 318 or the information stored in the image storage unit 319, and software.

Although the image display unit 320 can be implemented by an external device such as a viewer, it is possible to form the unit as a device attached to the PACS/viewer apparatus 303. The image display unit 320 is a device to superimpose and display the processed image and the image-attached CAD information which are associated with each other. This device allows the user to check a CAD result.

### <4. Processing Procedure in Medical Image Diagnosis Support System>

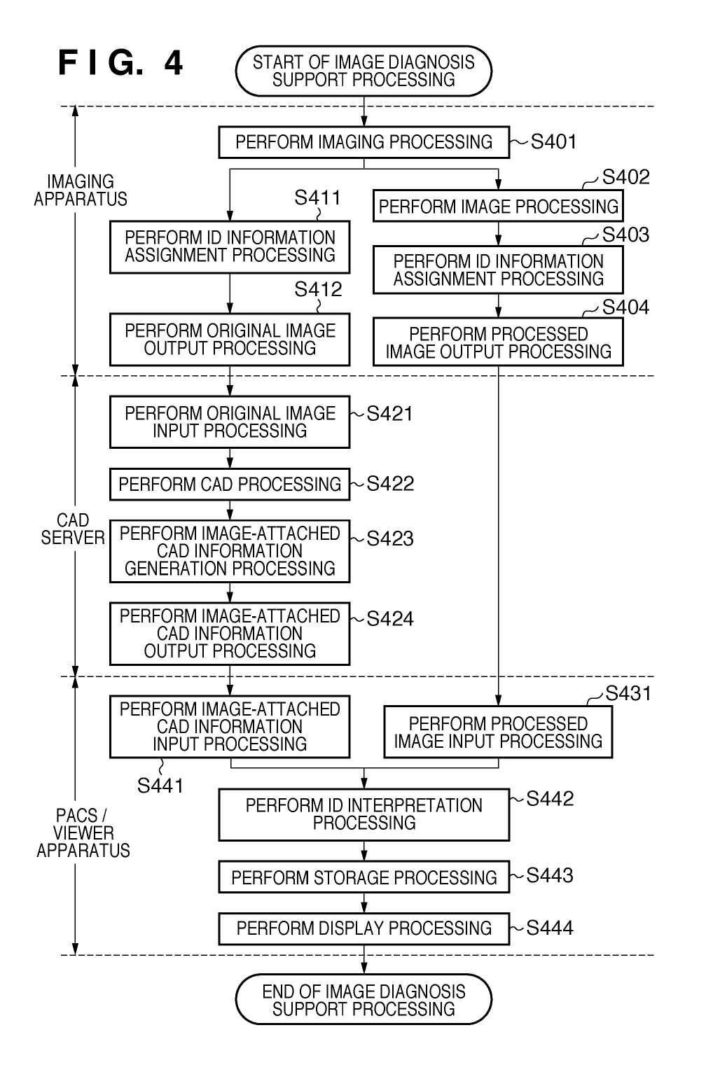

A processing procedure in the medical image diagnosis support system (a processing procedure to be performed when a medical image acquired by one imaging operation is processed) will be described with reference FIG. 4.

Note that the imaging apparatus 101 executes the processing in steps S401 to S412. The CAD server 102 executes the processing in steps S421 to S424. The PACS/viewer apparatus 103 executes the processing in steps S431 to S444.

In addition, the branches in the flowchart do not indicate conditional branches but indicate that parallel processing can be performed.

In step S401, the imaging unit 304 acquires a medical image (original image) of a target region of an object by executing processing suitable for an imaging apparatus, for example, X-ray exposure, the emission of light by a light-emitting source, the generation of ultrasonic waves, and the generation of a magnetic field.

In step S411, the ID information assigning unit 311 assigns at least ID information to the original image obtained in step S401. Note that in this case, the ID information assigning unit 311 can generate DICOM information from a DICOM image by using information in the imaging execution information holding unit 309 and patient information holding unit 310.

In step S412, the input/output unit 312 outputs the original image.

In step S402, the image processing unit 307 executes image processing for the original image by using the image processing parameter held in the image processing parameter holding unit 306. The image processing in step S402 obtains a processed image.

In step S403, the ID information assigning unit 311 assigns the same ID information as that assigned in step S411.

In step S404, the input/output unit 312 outputs the processed image.

In step S421, the input/output unit 313 acquires the original image. In step S422, the CAD processing unit 314 performs CAD processing for the original image with little signal degradation. The CAD processing in step S422 generates a CAD result.

In step S423, the image-attached CAD information generating unit 315 generates image-attached CAD information by assigning the ID information obtained from the original image to the CAD result from the CAD processing unit 314.

In step S424, the input/output unit 316 outputs the image-attached CAD information generated by the image-attached CAD information generating unit 315 to the PACS/viewer apparatus 303.

In step S441, the input/output unit 317 acquires the image-attached CAD information. In step S431, the input/output unit 317 acquires the processed image.

In step S442, the ID information interpretation unit 318 collates the ID information of the acquired image-attached CAD information with the ID information of the processed image. If they match, the ID information interpretation unit 318 generates related information of the two pieces of information.

If they do not match, the ID information interpretation unit 318 acquires the ID information of information stored in the image storage unit 319 for each piece of information, and collates the pieces of acquired information. If they match, the ID information interpretation unit 318 generates related information.

In step S443, the image storage unit 319 stores the processed image and the image-attached CAD information upon associating them based on the related information generated by the ID information interpretation unit 318.

In step S444, the image storage unit 319 superimposes and displays the processed image and the image-attached CAD information stored in the image storage unit 319.

As is obvious from the above description, this embodiment is configured to install the CAD server in the medical image diagnosis support system independently of the imaging apparatus and the PACS/viewer apparatus. This makes it possible to improve the processing efficiency of CAD processing.

In addition, this embodiment is configured to transmit an original image free from signal degradation due to image processing to the CAD server 102. This allows the CAD server 102 to perform CAD processing for a medical image suitable for signal analysis, thereby improving the analysis accuracy of CAD processing.

### Second Embodiment

In the first embodiment, an original image is associated with a processed image by using ID information assigned by the ID information assigning unit. If, however, the image processing unit is executing image processing such as rotation, enlargement/reduction, horizontal/vertical reversal, tone reversal, or slicing when generating a processed image, the coordinates of the original image are different from those of the processed image.

For example, the coordinates (100, 100) of an original image having a size of 1000×1000 are transformed into the coordinates (100, 900) after vertical reversal processing, resulting in coordinate differences.

Such a difference leads to a mismatch between the CAD result after processing by the CAD processing unit and a processed image. This finally makes the image-attached CAD information stored in the image storage unit lose its significance in supporting diagnosis by the doctor.

ID information for associating an original image with a processed image includes information indicating what type of image processing has been performed by the image processing unit. Reflecting such information in the ID information makes it possible to eliminate the mismatch between the CAD result and the processed image.

The functional arrangement of each apparatus constituting the medical image diagnosis support system according to the second embodiment of the present invention and a processing procedure will be described below with reference to the accompanying drawings. Since the arrangement of the medical image diagnosis support system and the hardware arrangement of each apparatus are the same as those of the first embodiment, a repetitive description will be omitted.

<1. Functional Arrangement of Each Apparatus Constituting Medical Image Diagnosis Support System>

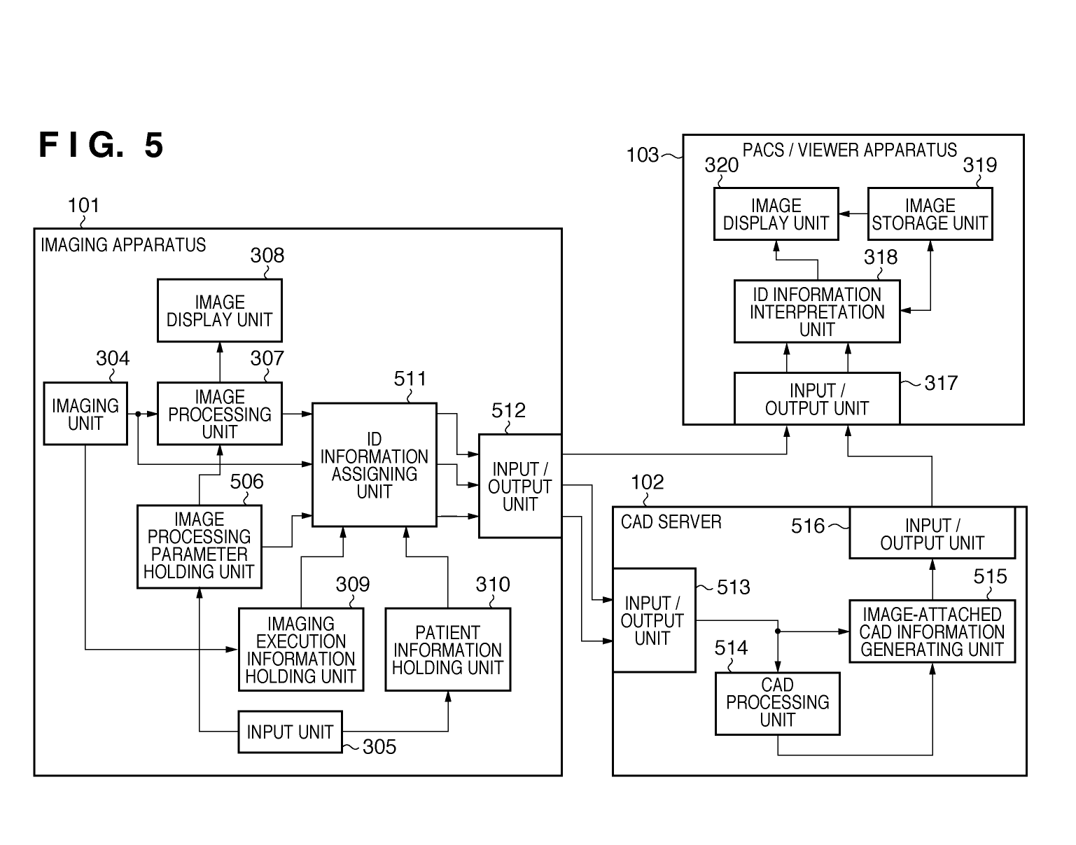

The functional arrangement of each apparatus constituting the medical image diagnosis support system will be described first. FIG. 5 is a block diagram showing the functional arrangement of each apparatus constituting the medical image diagnosis support system according to this embodiment. Note that the same reference numerals as in the first embodiment denote the same functions in the second embodiment. The following description will be made with a focus on a difference from the first embodiment.

The difference from the first embodiment is that an image processing parameter holding unit 506 transmits an image processing parameter to an ID information assigning unit 511, and an output from the ID information assigning unit 511 is transmitted to an input/output unit 512. In accordance with this operation, an input/output unit 513 and a CAD processing unit 514 or an image-attached CAD information generating unit 515 also have functions different from those in the first embodiment.

More specifically, the image processing parameter holding unit 506 has a function of transmitting an image processing parameter to the ID information assigning unit 511, in addition to the function described in the first embodiment.

The ID information assigning unit 511 also assigns pieces of ID information corresponding to an original image and a processed image to the image processing parameter transmitted from the image processing parameter holding unit 506.

The input/output unit 512 has a function of outputting the image processing parameter assigned with the pieces of ID information by the ID information assigning unit 511, in addition to the function described in the first embodiment.

Note that the following description is based on the assumption that the ID information assigning unit 511 transmits information to the input/output unit 512. However, the ID information assigning unit 511 may contain an image processing parameter in the header information of an original image. Note, however, that the input/output unit 512 may execute the processing of containing an image processing parameter in the header information of an original image.

In addition, the ID information assigning unit 511 may have a function of generating an image processing parameter as a GSPS object. In this case, a GSPS object is the one corresponding to an original image.

In this case, since the information of a GSPS object includes no item for slicing, it is conceivable to use a method of storing a slicing parameter as shutter information of the GSPS object. Alternatively, it is conceivable to use a method of storing overlay information for masking the area of an original image except for a sliced area as overlay information of a GSPS object.

The input/output unit 513 of the CAD server 102 has a function of receiving an original image and an image processing parameter output from the input/output unit 512, in addition to the function described in the first embodiment. In this case, there are the following two ways of receiving an original image and an image processing parameter.

One way is used when an image processing parameter is contained in the header information of an original image in an imaging apparatus 101. The other way is used when an original image and an image processing parameter are output as different pieces of information with corresponding pieces of ID information. Note that when the header information of an original image contains an image processing parameter, there is no need to perform ID interpretation.

If, however, an original image and an image processing parameter are different pieces of information, it is necessary to perform ID interpretation. Either the input/output unit 513, the CAD processing unit 514, or the image-attached CAD information generating unit 515 can possess this ID interpretation function.

The following description is based on the assumption that either of the above processing units interprets ID information, and an original image and an image processing parameter have already been associated with each other.

The CAD processing unit 514 performs CAD processing in consideration of the image processing parameter acquired from the input/output unit 513 after executing CAD processing.

More specifically, the CAD processing unit 514 performs processing corresponding to an image processing parameter, for example, inserting horizontal reversal processing for a horizontal reversal parameter or inserting coordinate correction processing for a slicing parameter.

However, the way of performing processing sharing is not limited to this. For example, the CAD processing unit 514 is configured to output a CAD result corresponding to a general original image (with no consideration being given to image processing parameters). The image-attached CAD information generating unit 515 can be configured to acquire an image processing parameter and generate image-attached CAD information corresponding to the image processing parameter.

<2. Processing Procedure in Medical Image Diagnosis Support System>

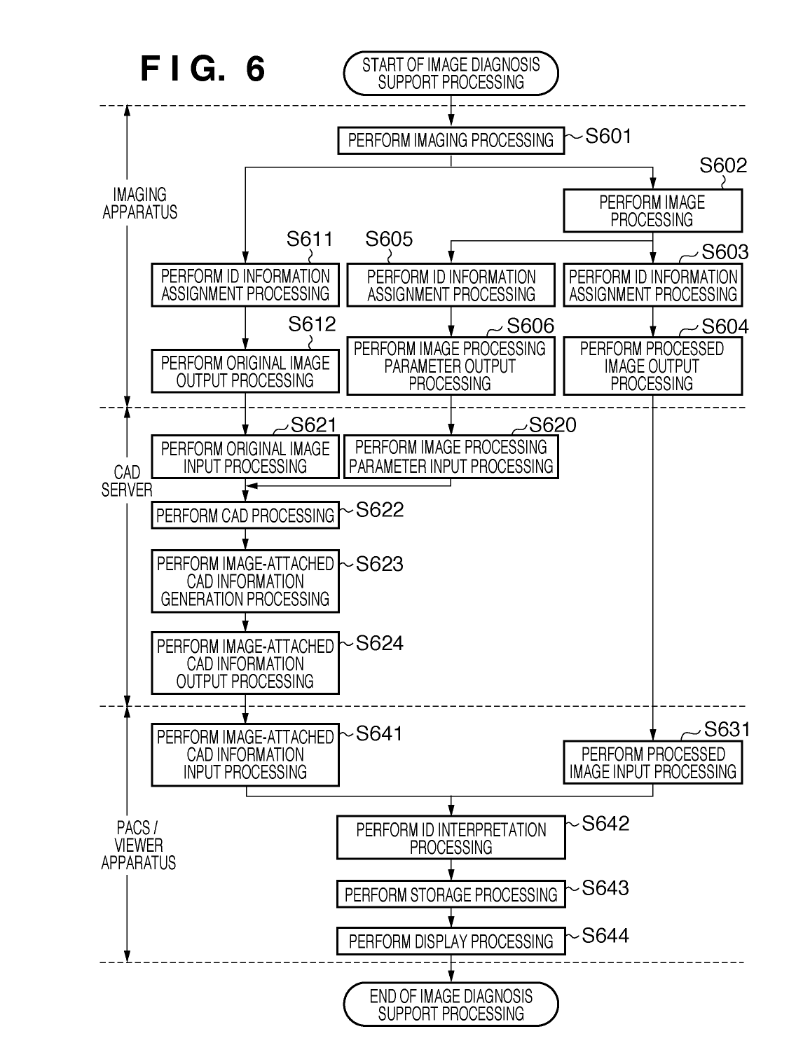

A processing procedure in the medical image diagnosis support system according to this embodiment (a processing procedure to be performed when a medical image acquired by one imaging operation is processed) will be described next with reference to FIG. 6.

The imaging apparatus 101 executes the processing in steps S601 to S612. The CAD server 102 executes the processing in steps S620 to S624. A PACS/viewer apparatus 103 executes the processing in steps S631 to S644.

In addition, the branches in the flowchart do not indicate conditional branches but indicate that parallel processing can be performed.

Of the above processing, the processing in steps S601 to S604, S611, and S612 is the same as that in steps S401 to S404, S411, and S412, which has been described in the first embodiment with reference to FIG. 4.

In addition, the processing in steps S621, S623, and S624 and in steps S631 to S644 is the same as that in steps S421, S423, and S424 and in steps S431 to S444 described in the first embodiment with reference to FIG. 4.

A description of these processes will be omitted. A difference from the first embodiment will be described below.

In step S605, the ID information assigning unit 511 assigns pieces of ID information corresponding to the pieces of ID information assigned in steps S603 and S611 to the image processing parameter held in the image processing parameter holding unit 506.

In step S606, the input/output unit 512 outputs the image processing parameter.

In step S620, the input/output unit 513 acquires an image processing parameter. In step S622, the CAD processing unit 514 performs CAD processing for an original image, and the input/output unit 513 performs processing corresponding to a processed image by using the image processing parameter acquired by the input/output unit 513.

Alternatively, in step S623, the image-attached CAD information generating unit 515 generates image-attached CAD information corresponding to the processed image by using the image processing parameter acquired by the input/output unit 513. With this operation, the image processing parameter is reflected in the CAD result.

As is obvious from the above description, this embodiment is configured to transmit, to the CAD server 102, the image processing parameter which has been used for image processing when generating the processed image upon assigning ID information.

This makes it possible to eliminate the mismatch between a CAD result and a processed image due to coordinate differences accompanying image processing.

### Third Embodiment

The first and second embodiments are configured to make the imaging apparatus execute image processing. However, the present invention is not limited to this. However, each embodiment may be configured to make the CAD server execute image processing. The arrangement of a medical image diagnosis support system according to the third embodiment of the present invention, the functional arrangement of each apparatus, and a processing procedure will be described below.

<1. Arrangement of Medical Image Diagnosis Support System>

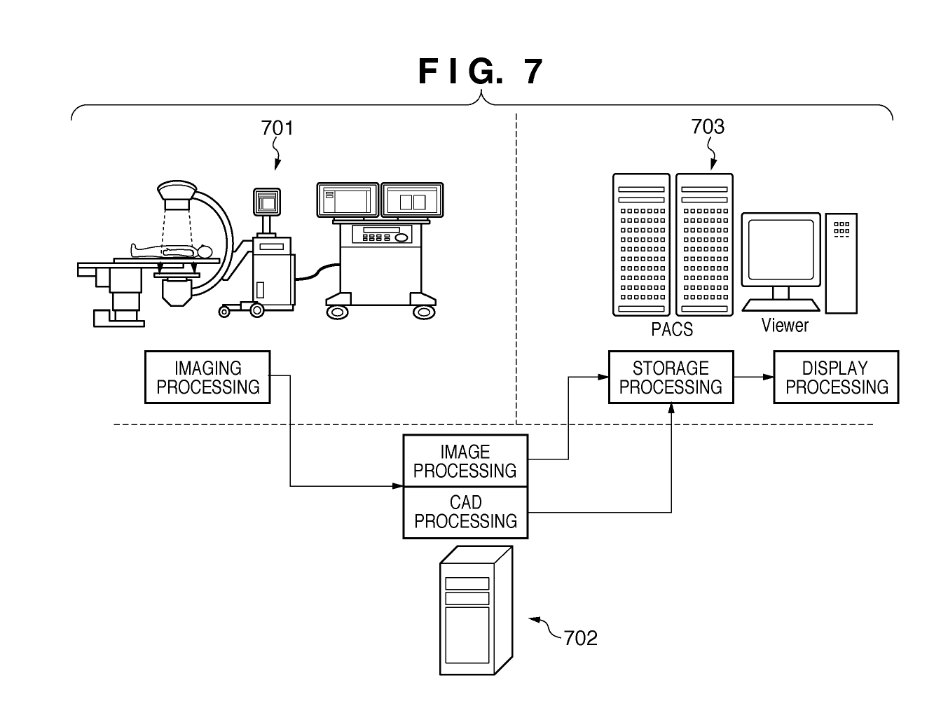

FIG. 7 is a view showing the arrangement of the medical image diagnosis support system according to this embodiment. Although an imaging apparatus 701, a CAD server 702, and a PACS/viewer apparatus 703 are identical to the imaging apparatus 101, the CAD server 102, and the PACS/viewer apparatus 103 in the first embodiment described above, their functions differ from each other.

The imaging apparatus 701 performs only imaging processing and outputs an original image. In addition, the CAD server 702 performs image processing in addition to CAD processing. As described above, the medical image diagnosis support system according to this embodiment is characterized in that the CAD server 702 executes image processing and CAD processing.

According to this embodiment, making the CAD server 702 have an image processing function can reduce the cost as compared with a case in which a plurality of imaging apparatus are made to have image processing functions.

<2. Functional Arrangement of Each Apparatus Constituting Medical Image Diagnosis Support System>

The functional arrangement of each apparatus constituting the medical image diagnosis support system according to this embodiment will be described next.

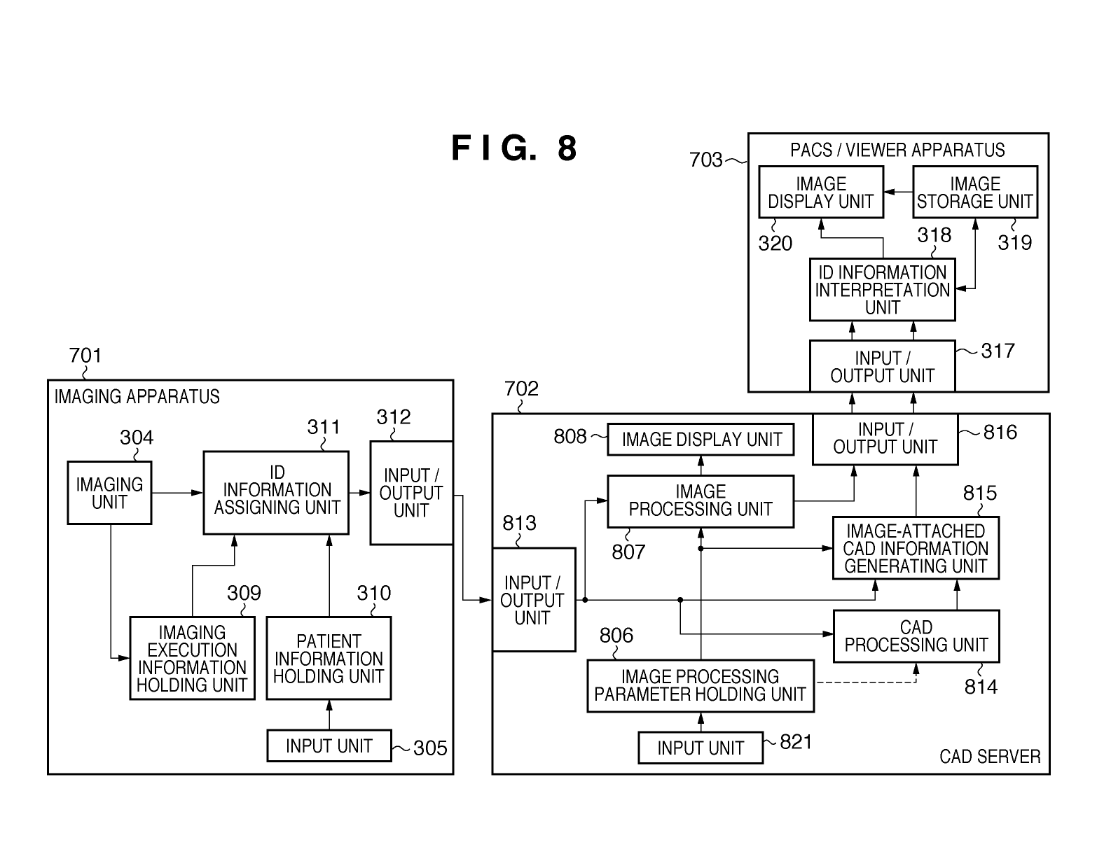

FIG. 8 is a block diagram showing the functional arrangement of each apparatus constituting the medical image diagnosis support system according to this embodiment. The following description will be made with a focus on differences from the functional arrangement (FIG. 3) of each apparatus constituting the medical image diagnosis support system described in the first embodiment.

The main difference from the arrangement in FIG. 3 is that an image processing parameter holding unit 806, an image processing unit 807, and an image display unit 808 are arranged in the CAD server 702 instead of the imaging apparatus 701. In addition, a difference lies in that the CAD server 702 includes an input unit 821 having the same function and arrangement as those of an input unit 305.

The image processing parameter holding unit 806 holds an image processing parameter including at least a noise suppression parameter, a sharpness intensity, a rotational angle, an enlargement/reduction ratio, the execution/non-execution of horizontal/vertical reversal, the execution/non-execution of tone reversal, or an area to be sliced, which is input from the input unit 821.

The image processing unit 807 and the image display unit 808 have the same functions as those of the image processing unit 307 and image display unit 308 in the first embodiment.

An image-attached CAD information generating unit 815 converts the CAD result obtained by a CAD processing unit 814 into information corresponding to a processed image based on information from the image processing parameter holding unit 806, and assigns the ID information of an original image to the information. This makes it possible to eliminate the coordinate differences between the CAD result and the processed image.

Note that instead of the image-attached CAD information generating unit 815, the CAD processing unit 814 can perform this processing based on information in the image processing parameter holding unit 806.

<3. Processing Procedure in Medical Image Diagnosis Support System>

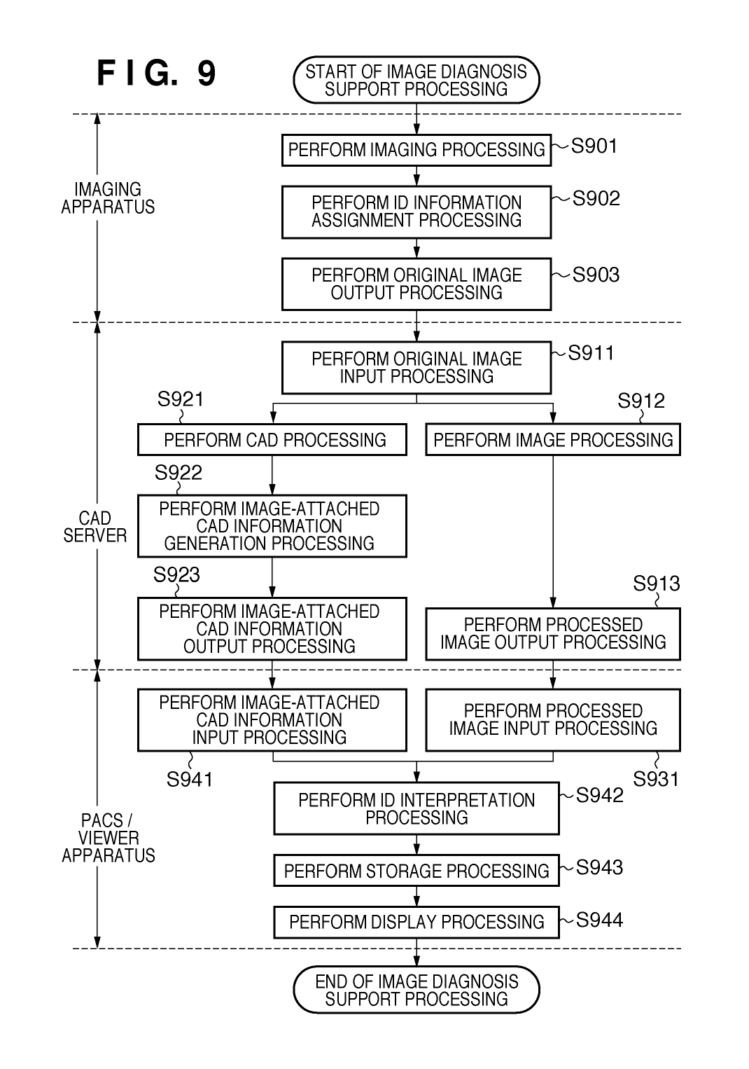

A processing procedure in the medical image diagnosis support system according to this embodiment (a processing procedure to be performed when a medical image acquired by one imaging operation is processed) will be described next with reference to FIG. 9.

The imaging apparatus 701 executes the processing in steps S901 to S903. The CAD server 702 executes the processing in steps S911 to S923. The PACS/viewer apparatus 703 executes the processing in steps S931 to S944.

In addition, the branches in the flowchart do not indicate conditional branches but indicate that parallel processing can be performed.

Of the above processing, the processing in steps S901 to S903, S911 to S913, S922 to S923, and S931 to S944 is the same as that in the first embodiment.

A detailed description of these processes will be omitted. A difference from the first embodiment will be described below.

In step S921, the CAD processing unit 814 performs CAD processing for an original image, and uses the image processing parameter held in the image processing parameter holding unit 806, thereby performing conversion processing corresponding to a processed image.

Alternatively, in step S922, the image-attached CAD information generating unit 815 generates image-attached CAD information corresponding to the processed image by using the image processing parameter held in the image processing parameter holding unit 806.

As is obvious from the above description, this embodiment is configured to make the imaging apparatus 701 perform only imaging processing to output an original image and to make the CAD server 702 perform CAD processing and image processing.

This makes it possible to reduce the cost as compared with a case in which each imaging apparatus is made to have an image processing function.

### Fourth Embodiment

The third embodiment is configured to make the CAD server execute CAD processing and image processing and transmit the CAD result and the processed image to the PACS/viewer apparatus upon associating them with each other. However, the present invention is not limited to this. For example, it is possible to combine a CAD result and a processed image first and then transmit the resultant data to the PACS/viewer apparatus.

The arrangement of a medical image diagnosis support system according to the fourth embodiment of the present invention, the functional arrangement of each apparatus, and a processing procedure will be described below.

<1. Arrangement of Medical Image Diagnosis Support System>

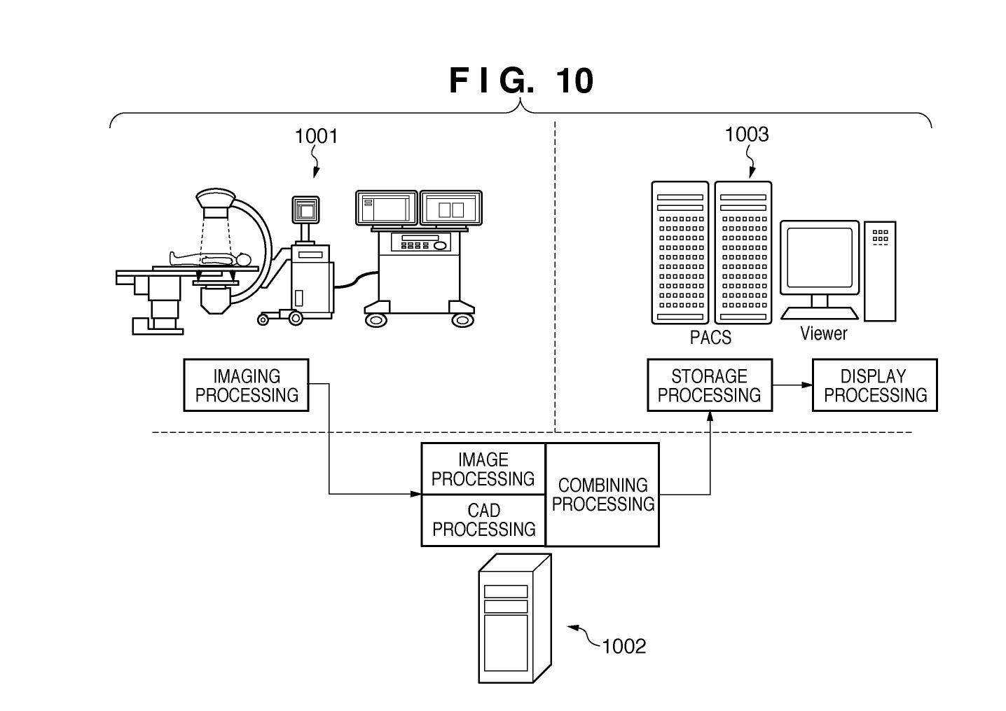

FIG. 10 is a view showing the arrangement of the medical image diagnosis support system according to this embodiment. Although an imaging apparatus 1001, a CAD server 1002, and a PACS/viewer apparatus 1003 are identical to the imaging apparatus 101, the CAD server 102, and the PACS/viewer apparatus 103 in the first embodiment described above, their functions differ from each other.

The imaging apparatus 1001 performs only imaging processing and outputs an original image. In addition, the CAD server 1002 performs image processing in addition to CAD processing. In addition, the CAD server 1002 performs the combining processing of combining the processed image and the CAD result and then outputs the resultant data to the PACS/viewer apparatus 1003.

The medical image diagnosis support system according to this embodiment is characterized in that the CAD server 1002 executes image processing, CAD processing, and combining processing.

According to this embodiment, the PACS/viewer apparatus 1003 stores one piece of information. This can facilitate management of information in the PACS/viewer apparatus 1003 as compared with the first to third embodiments.

Even in a hospital where a PACS/viewer apparatus has already been installed, it is also possible to construct a medical image diagnosis support system relatively easily (without replacing the PACS/viewer apparatus).

<2. Functional Arrangement of Each Apparatus Constituting Medical Image Diagnosis Support System>

The functional arrangement of each apparatus constituting the medical image diagnosis support system according to this embodiment will be described next.

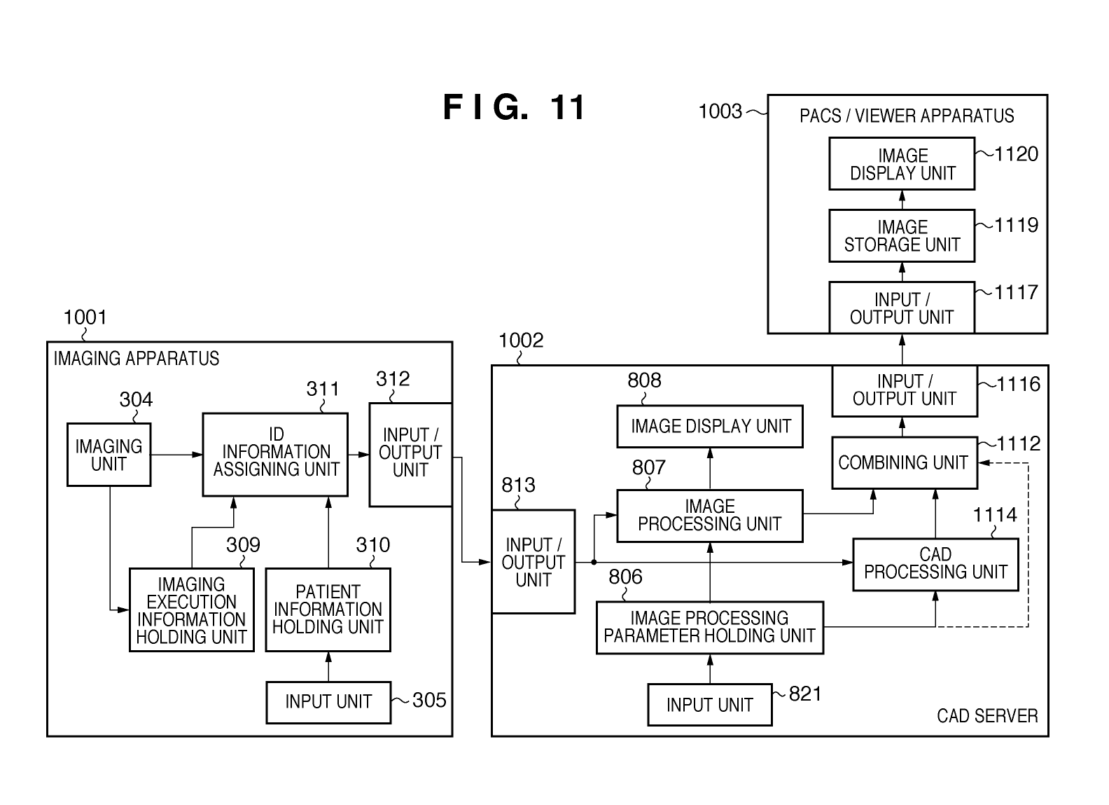

FIG. 11 is a block diagram showing the functional arrangement of each apparatus constituting the medical image diagnosis support system according to this embodiment. The following description will be made with a focus on differences from the functional arrangement (FIG. 8) of each apparatus constituting the medical image diagnosis support system.

The main difference from the arrangement in FIG. 8 is that the CAD server 1002 includes no image-attached CAD information generating unit but additionally includes a combining unit 1112. In addition, a difference lies in that the PACS/viewer apparatus 1003 includes no ID interpretation unit.

In the CAD server 1002, the combining unit 1112 combines the processed image obtained by an image processing unit 807 with the CAD result obtained from a CAD processing unit 1114 to generate an image in which the CAD result is embedded.

In addition, the CAD processing unit 1114 performs CAD processing corresponding to a processed image by using the image processing parameter obtained from an image processing parameter holding unit 806. Note however that instead of the CAD processing unit 1114, the combining unit 1112 can perform processing corresponding to this processed image by acquiring an image processing parameter from the image processing parameter holding unit 806.

In the PACS/viewer apparatus 1003, an input/output unit 1117 receives the image obtained by combining a processed image and a CAD result. An image storage unit 1119 stores the image obtained from the input/output unit 1117. An image display unit 1120 displays the image stored in the image storage unit 1119.

<3. Processing Procedure in Medical Image Diagnosis Support System>

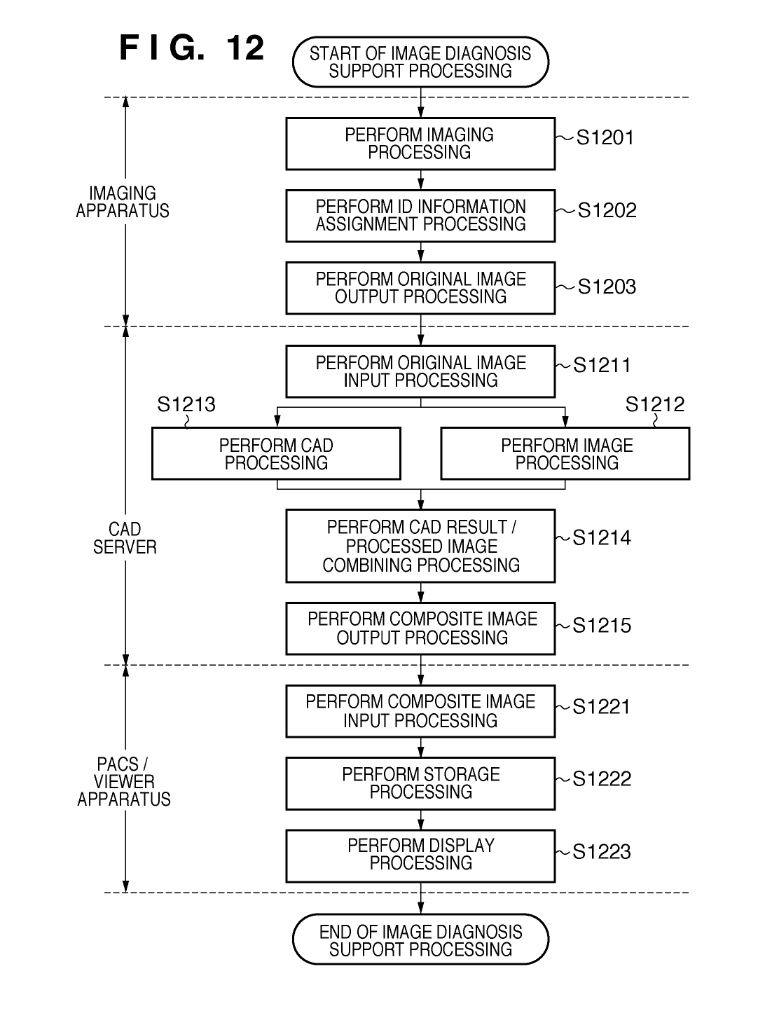

A processing procedure in the medical image diagnosis support system according to this embodiment (a processing procedure to be performed when a medical image acquired by one imaging operation is processed) will be described next with reference to FIG. 12.

The imaging apparatus 1001 executes the processing in steps S1201 to S1203. The CAD server 1002 executes the processing in steps S1211 to S1215. The PACS/viewer apparatus 1003 executes the processing in steps S1221 to S1223.

In addition, the branches in the flowchart do not indicate conditional branches but indicate that parallel processing can be performed.

Of the above processing, the processing in steps S1201 to S1203, S1211, S1212, S1222, and S1223 is the same as that in the third embodiment.

A detailed description of these processes will be omitted. Differences from the third embodiment will be described below.

In step S1213, the CAD processing unit 1114 performs CAD processing for an original image, and also performs conversion processing by using the image processing parameter held in the image processing parameter holding unit 806 to make the original image correspond to a processed image.

In step S1214, the combining unit 1112 acquires a processed image from an image processing unit 807, acquires a CAD result from the CAD processing unit 1114, and embeds the CAD result in the processed image (combining processing).

Note that the combining unit 1112 can perform the conversion processing of making the CAD result correspond to the processed image by using the image processing parameter acquired from an image processing parameter holding unit 806 before the combining processing in step S1214.

In step S1215, an input/output unit 1116 outputs the composite image generated by the combining unit 1112.

In step S1221, the input/output unit 1117 receives the composite image obtained by combining the processed image and the CAD result.

In step S1222, the image storage unit 1119 stores the acquired composite image. In step S1223, the image display unit 1120 superimposes and displays the processed image and the CAD result contained in the composite image stored in the image storage unit 1119.

As is obvious from the above description, this embodiment is configured to make the CAD server 1002 perform CAD processing and image processing and combine the CAD result and the processed image.

This facilitates the management of information in the PACS/viewer apparatus 1003 as compared with the first to third embodiments.

### Fifth Embodiment

The first and second embodiments are configured to make the imaging apparatus execute image processing. The third and fourth embodiments are configured to make the CAD server execute image processing. However, the present invention is not limited to this. For example, it is possible to make the PACS/viewer apparatus execute image processing. The arrangement of a medical image diagnosis support system according to the fifth embodiment of the present invention, the functional arrangement of each apparatus, and a processing procedure will be described below.

<1. Arrangement of Medical Image Diagnosis Support System>

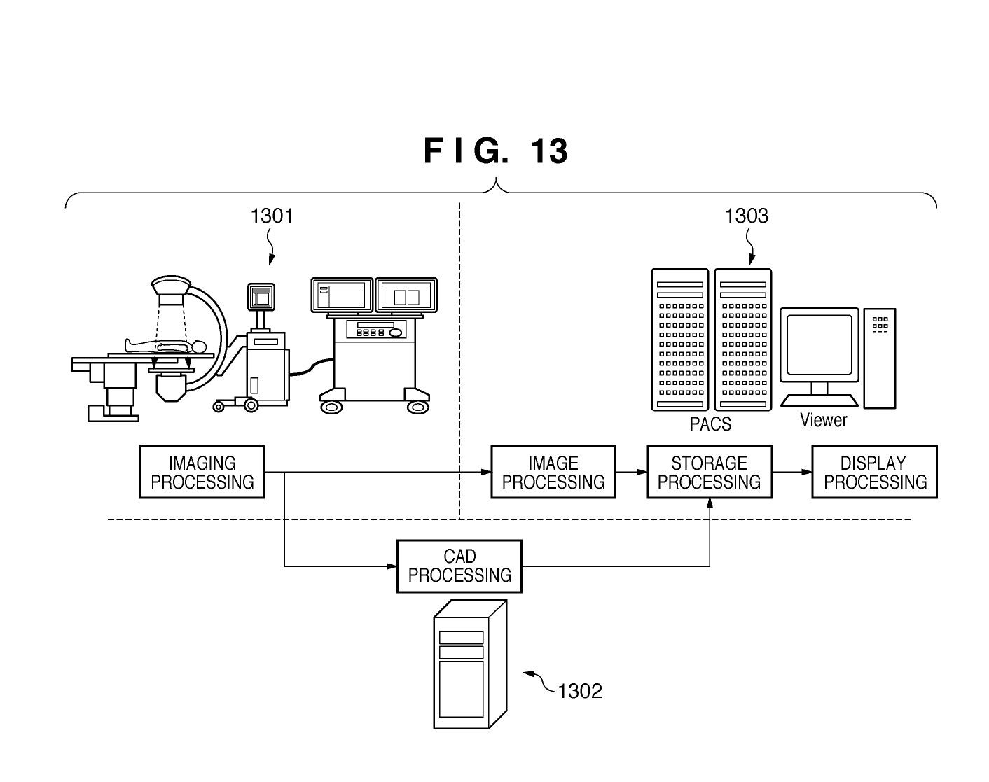

FIG. 13 is a view showing the arrangement of the medical image diagnosis support system according to this embodiment. Although an imaging apparatus 1301, a CAD server 1302, and a PACS/viewer apparatus 1303 are identical to the imaging apparatus 101, the CAD server 102, and the PACS/viewer apparatus 103 in the first embodiment described above, their functions differ from each other.

The CAD server 1302 executes CAD processing and outputs the CAD processing result. The PACS/viewer apparatus 1303 performs image processing in addition to storage processing and display processing. As described above, the medical image diagnosis support system according to this embodiment is characterized in that the PACS/viewer apparatus 1303 executes image processing.

According to this embodiment, making the PACS/viewer apparatus 1303 possess the image processing function can suppress image quality differences due to the image processing algorithms of the respective imaging apparatuses. This makes it possible to hold constant image quality.

This makes it possible to reduce the cost as compared with a case in which a plurality of imaging apparatuses or a plurality of CAD servers are made to have image processing functions.

<2. Functional Arrangement of Each Apparatus Constituting Medical Image Diagnosis Support System>

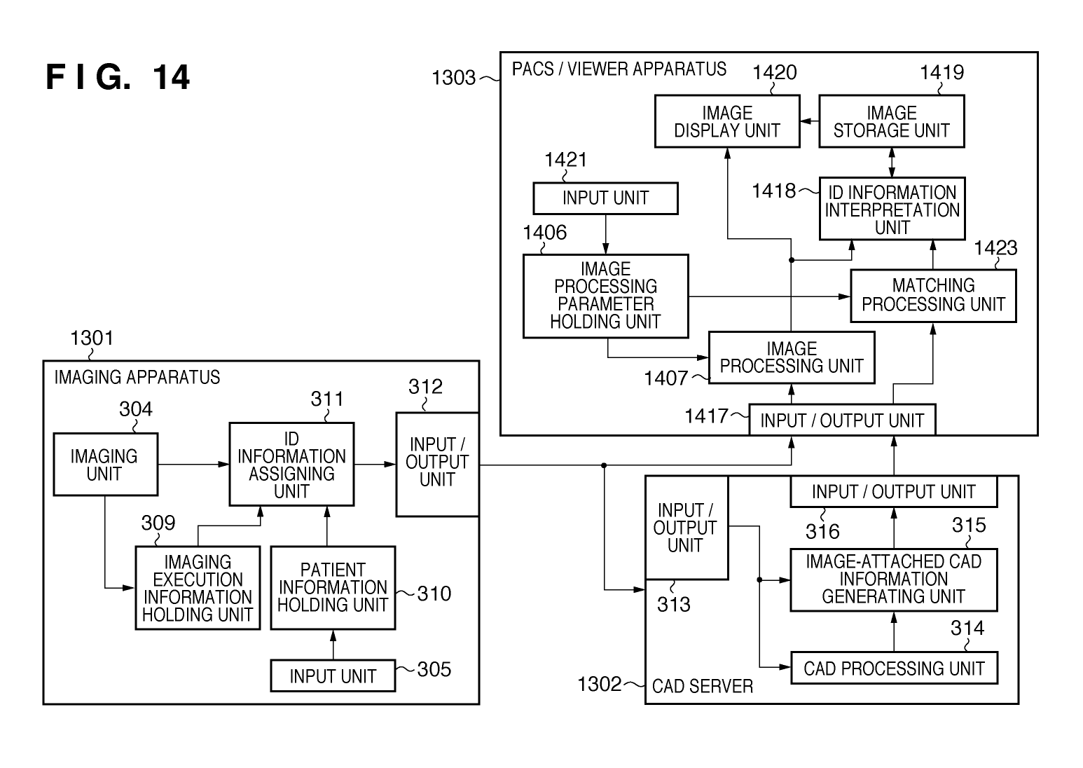

FIG. 14 is a block diagram showing the functional arrangement of each apparatus constituting the medical image diagnosis support system according to this embodiment. The following description will be made with a focus on differences from the functional arrangement (FIG. 8) of each apparatus constituting the medical image diagnosis support system described in the third embodiment.

The main difference from the arrangement in FIG. 8 is that the CAD server 1302 includes no image display unit, and the PACS/viewer apparatus 1303 includes an image processing parameter holding unit 806, an image processing unit 807, and an input unit 821 which were included in the CAD server 702. In addition, a difference lies in that the PACS/viewer apparatus 1303 newly includes a matching processing unit 1423.

In the PACS/viewer apparatus 1303, an image processing parameter holding unit 1406, an image processing unit 1407, and an input unit 1421 have the same functions as those of the image processing parameter holding unit 806, image processing unit 807, and input unit 821 in the third embodiment described above.

The matching processing unit 1423 performs the processing of establishing matching between the image-attached CAD information corresponding to the original image, which is obtained by acquiring an image processing parameter from the image processing parameter holding unit 1406, and the processed image generated by the image processing unit 1407. With this processing, the image processing parameter is reflected in the CAD result.

An image display unit 1420 can display the processed image obtained by the image processing unit 1407 and the original image before image processing by the image processing unit 1407.

<3. Functional Arrangement of Each Apparatus Constituting Medical Image Diagnosis Support System>

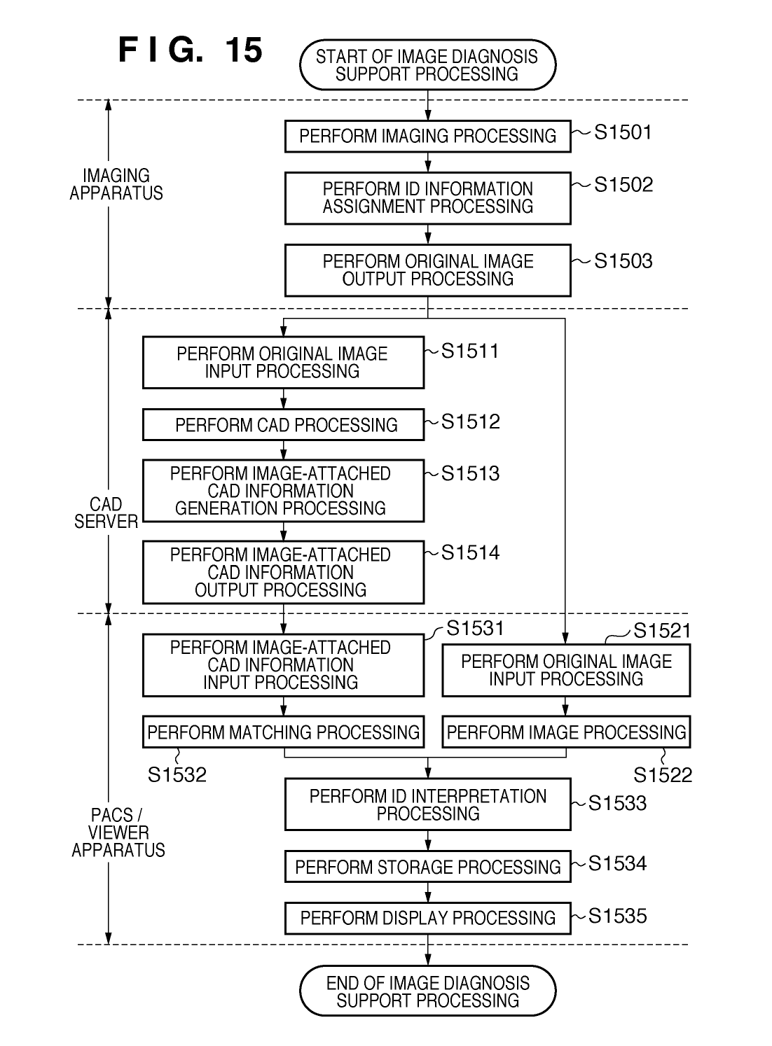

A processing procedure in the medical image diagnosis support system according to this embodiment (a processing procedure to be performed when a medical image acquired by one imaging operation is processed) will be described next with reference to FIG. 15.

The imaging apparatus 1301 executes the processing in steps S1501 to S1503. The CAD server 1302 executes the processing in steps S1511 to S1514. The PACS/viewer apparatus 1303 executes the processing in steps S1531 to S1535.

In addition, the branches in the flowchart do not indicate conditional branches but indicate that parallel processing can be performed.

Of the above processing, the processing in steps S1501 to S1503, S1511, S1514, S1522, S1531, S1533, S1534, and S1535 is the same as that in the third embodiment described above.

The processing in steps S1512 and S1513 is the same as that in the first embodiment described above.

A detailed description of these processes will be omitted, and differences from the first and third embodiments will be described below.

In step S1521, an input/output unit 1417 acquires an original image.

In step S1532, the matching processing unit 1423 acquires an image processing parameter from the image processing parameter holding unit 1406, and performs conversion processing so as to match image-attached CAD information corresponding to the original image with a processed image.

Although not shown in the accompanying drawings, the image display unit 1420 can superimpose and display the processed image stored in an image storage unit 1419 and the image-attached CAD information at any timing.

As is obvious from the above description, this embodiment is configured to make the PACS/viewer apparatus 1303 perform image processing.

This makes it possible to suppress image quality differences due to the image processing algorithms of the respective imaging apparatuses and hold constant image quality.

In addition, this makes it possible to reduce the cost as compared with a case in which a plurality of imaging apparatuses or a plurality of CAD servers are made to have image processing functions.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-003990 filed Jan. 9, 2009, which is hereby incorporated by reference herein in its entirety.

What is claimed is:

1. A medical image diagnosis support system comprising an imaging apparatus which images an object, a processing apparatus which executes CAD processing of analyzing an input medical image, and a storage apparatus which stores input information, said imaging apparatus, said processing apparatus, and said storage apparatus being connected to each other, the system comprising:
a first processing path in which information obtained by executing image processing including one of noise suppression processing and sharpening processing for a medical image obtained by making said imaging apparatus image the object is stored in said storage apparatus;
a second processing path in which information obtained by executing the CAD processing for a medical image obtained by making said imaging apparatus image the object is stored in said storage apparatus; and
a processing unit configured to execute, in said first processing path and said second processing path, a process of associating the information stored in said storage apparatus in said first processing path with the information stored in said storage apparatus in said second processing path.

2. The system according to claim 1, wherein said processing unit assigns pieces of related identification information, respectively, to the information stored in said storage apparatus in said first processing path and the information stored in said storage apparatus in said second processing path.

3. The system according to claim 1, wherein said processing unit combines the information stored in said storage apparatus in said first processing path and the information stored in said storage apparatus in said second processing path into one piece of information.

4. The system according to claim 2 or 3, wherein the image processing further includes one of rotation processing, enlargement/reduction processing, horizontal/vertical reversal processing, and tone reversal processing for the medical image, and
in said second processing path, a parameter used to execute image processing in said first processing path is reflected in information obtained by executing the CAD processing.

5. The system according to claim 1, wherein the image processing is executed by said imaging apparatus.

6. The system according to claim 1, wherein the image processing is executed by said processing apparatus.

7. The system according to claim 1, wherein the image processing is executed by said storage apparatus.

8. An image processing method in a medical image diagnosis support system comprising an imaging apparatus which images an object, a processing apparatus which executes CAD processing of analyzing an input medical image, and a storage apparatus which stores input information, the imaging apparatus, the processing apparatus, and the storage apparatus being connected to each other, the method comprising the steps of:
storing, in the storage apparatus, information obtained by executing image processing including one of noise suppression processing and sharpening processing for a medical image obtained by making the imaging apparatus image the object;
storing, in the storage apparatus, information obtained by executing the CAD processing for a medical image obtained by making the imaging apparatus image the object; and
executing, in the step of storing information obtained by executing image processing and the step of storing information obtained by executing the CAD processing, a process of associating the information stored in the storage apparatus in the step of storing information obtained by executing image processing with the information stored in the storage apparatus in the step of storing information obtained by executing the CAD processing.
